(19) United States
(12) Patent Application Publication
(10) Pub. No.: US 2026/0267154 A1
(43) Pub. Date: Sep. 10, 2026

(54) ONLINE CALIBRATION OF SMARTGLASSES FRAME DEFORMATION

(71) Applicant: GOOGLE, LLC, Mountain View, CA (US)

(72) Inventors: Zhiheng Jia, Sunnyvale, CA (US); Joshua Anthony Hernandez, Redwood City, CA (US); Chao Guo, Los Altos, CA (US); Qiyue Zhang, Santa Clara, CA (US)

(21) Appl. No.: 19/121,035

(22) PCT Filed: Oct. 17, 2022
(86) PCT No.: PCT/US2022/078197

§ 371 Date: Apr. 14, 2025

(51) Int. Cl. G02B 27/01; G02B 27/00

(52) U.S. Cl. CPC G02B 27/0176; G02B 27/0093; G02B 2027/0178

(57) ABSTRACT

Techniques of maintaining user comfort while using augmented reality smartglasses include performing an online calibration of frame deformation to correct display position in the lens. Such a calibration involves modeling the frame portion between the world-facing camera and the eye-tracking camera as a hinge that rotates about an axis on and normal to the frame portion. That is, the frame portion consists of two line segments that are joined at an axis at an unknown rotation (angle) to be determined. In this treatment, any translation induced will be neglected.

### BACKGROUND

Eyewear in the form of glasses may be worn by a user to, for example, provide for vision correction, inhibit sun/glare, provide a measure of safety, and the like. These types of eyewear are typically somewhat flexible and/or deformable, so that the eyewear can be manipulated to comfortably fit the user. An ophthalmic technician can typically manipulate rim portions and/or temple arm portions of a frame of the eyewear, for example, through cold working the frame and/or heating and re-working the frame, to adjust the eyewear for a particular user. In some situations, this re-working of the frame may occur over time, through continued use/wearing of the eyewear by the user. Manipulation in this manner, due to the flexible and/or deformable nature of the material of the frame and/or lenses of the eyewear, may provide a comfortable fit while still maintaining ophthalmic alignment between the eyewear and the user. In a situation in which the eyewear is a head mounted computing device including a display, such as, for example, smartglasses, this type of flexibility/deformation in the frame may cause inconsistent alignment or the display, or misalignment of the display. Inconsistent alignment, or misalignment of the display can cause visual discomfort, particularly in the case of a binocular display. A frame having rigid/non-flexible components, while still providing some level of flexibility in certain portions of the frame, may maintain alignment of the display, and may be effective in housing electronic components of such a head mounted computing device including a display.

### SUMMARY

In one general aspect, a method can include receiving gyro data from a first gyro and a second gyro on a smartglasses device, the first gyro being associated with a world-facing camera on a frame of the smartglasses device, the second gyro being associated with an eye-tracking camera on a frame of the smartglasses device, the gyro data including a first rotational velocity of the world-facing camera, a second rotational velocity of the eye-tracking camera, and a rotation matrix representing an orientation of the eye-tracking camera relative to the world-facing camera. The method can also include generating a hinge rotation between the world-facing camera and the eye-tracking camera based on the gyro data, the hinge rotation indicating a level of deformation of the frame of the smartglasses device. The method can further include determining a position of a display within a lens of the smartglasses device based on the hinge rotation.

Based on the determined position, a (re-) calibration may be performed to correct the display position if the determined position differs about more than a (calibration) threshold from a reference position in order to enable and/or preserve accuracy of eye/gaze tracking with the eye-tracking camera. Such a calibration may be performed online by . . . . If a the determined position of the display is outside of calibration thresholds a recalibration is automatically triggered and/or a notification (e.g., message, alarm or the like) is generated informing—for example a user of the smartglasses device—of a detected deviation of the display within the lens that is to be corrected to not adversely impact visibility of visual content output by the display. Generally, the disclosed (re-) calibration may thus involve modeling the frame portion between the world-facing camera and the eye-tracking camera as a hinge that rotates about an axis on and normal to the frame portion. That is, the frame portion consists of two line segments that are joined at an axis at an unknown rotation (angle) to be determined. In this treatment, any translation induced will be neglected.

Implementations described herein may thus relate to calibration of frame deformations in a smartglasses device. Specifically, while an at least partially flexible frame provides a level of comfort to a user of the smartglasses device, the frame deformations that result may case a measure of discomfort due to misalignment of cameras disposed on the frame and the display projected onto the lens of the smartglasses device. For example, the relative orientation of the world-facing camera with respect to the eye-tracking camera on the frame is subject to perturbations when the frame is flexed. Moreover, this relative orientation may also change subject to temperature, frame age, and sudden shocks, e.g., dropping the smartglasses. Nevertheless, it has been determined that if a frame portion between the world-facing camera and the eye-tracking camera is modeled as a hinge that rotates about an axis normal to a point on the frame portion, then a hinge rotation may be determined via measurements from gyros attached or otherwise associated with each of the world-facing camera and the eye-tracking camera. Once the hinge rotation and values characterizing this hinge rotation are determined, the location of the display on the smartglasses device may be precisely and/or automatically corrected and comfort for the user may be maintained.

In some implementations, the gyro data includes a first noise term representing noise in the first gyro and a second noise term representing noise in the second gyro.

In some implementations, the first noise term and the second noise term are each gaussian white noise terms of equal width.

In some implementations, the gyro data includes a first bias term representing a rotational bias in the first gyro and a second bias term representing the rotational bias in the second gyro.

In some implementations, the first bias term and the second bias term are each constant with respect to time.

In some implementations, the gyro data includes a time delay between the world-facing camera and the eye-tracking camera.

In some implementations, generating the hinge rotation between the world-facing camera and the eye-tracking camera includes forming an initial state defined by the rotation matrix, an initial covariance matrix, a measurement noise matrix, and a process noise matrix; and applying an extended Kalman filter to the initial state, the first rotational velocity, and the second rotational velocity to produce an updated state estimate and an updated covariance matrix, the hinge rotation being based on an updated rotation matrix of the updated state estimate.

In some implementations, generating the hinge rotation between the world-facing camera and the eye-tracking camera includes forming an initial state defined by the rotation matrix, a first bias term representing a rotational bias in the first gyro, a second bias term representing the rotational bias in the second gyro, and a time delay between the world-facing camera and the eye-tracking camera; forming an initial covariance matrix, a measurement noise matrix, and a process noise matrix; and applying an extended Kalman filter to the initial state, the first rotational velocity, and the second rotational velocity to produce an updated state estimate and an updated covariance matrix, the hinge rotation being based on an updated rotation matrix of the updated state estimate.

In another general aspect, a computer program product comprises a nontransitory storage medium, the computer program product including code that, when executed by processing circuitry, causes the processing circuitry to perform a method. The method can include receiving gyro data from a first gyro and a second gyro on a smartglasses device, the first gyro being associated with a world-facing camera on a frame of the smartglasses device, the second gyro being associated with an eye-tracking camera on a frame of the smartglasses device, the gyro data including a first rotational velocity of the world-facing camera, a second rotational velocity of the eye-tracking camera, and a rotation matrix representing an orientation of the eye-tracking camera relative to the world-facing camera. The method can also include generating a hinge rotation between the world-facing camera and the eye-tracking camera based on the gyro data, the hinge rotation indicating a level of deformation of the frame of the smartglasses device. The method can further include determining a position of a display within a lens of the smartglasses device based on the hinge rotation.

In another general aspect, an apparatus comprises memory, and processing circuitry coupled to the memory. The processing circuitry can be configured to receive gyro data from a first gyro and a second gyro on a smartglasses device, the first gyro being associated with a world-facing camera on a frame of the smartglasses device, the second gyro being associated with an eye-tracking camera on the frame of the smartglasses device, the gyro data including a first rotational velocity of the world-facing camera, a second rotational velocity of the eye-tracking camera, and a rotation matrix representing an orientation of the eye-tracking camera relative to the world-facing camera. The processing circuitry can also be configured to generate a hinge rotation between the world-facing camera and the eye-tracking camera based on the gyro data, the hinge rotation indicating a level of deformation of the frame of the smartglasses device. The processing circuitry can further be configured to determine a position of a display within a lens of the smartglasses device based on the hinge rotation.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example head mounted wearable device worn by a user.

FIG. 1B is a front view, and FIG. 1C is a rear view of the example head mounted wearable device shown in FIG. 1A.

FIG. 2A is a perspective view, FIG. 2B is a top view, and FIG. 2C is a side view of a frame of the example head mounted wearable device shown in FIGS. 1A-1C, in a reference state.

FIG. 3A is a perspective view, FIG. 3B is a top view, and FIG. 3C is a side view of a frame of the example head mounted wearable device shown in FIGS. 1A-1C, in a first deformed state.

FIG. 4A is a perspective view, FIG. 4B is a top view, and FIG. 4C is a side view of a frame of the example head mounted wearable device shown in FIGS. 1A-1C, in a second deformed state.

FIG. 5A is a diagram illustrating an example orientation between a world-facing camera and an eye-tracking camera on a smartglasses frame.

FIG. 5B is a diagram illustrating an example, simplified hinge model of the frame deformation of the frame portion between the world-facing camera and the eye-tracking camera.

FIG. 6 is a diagram illustrating an example apparatus for performing the online calibration per the improved techniques described herein.

FIG. 7 is a flow chart illustrating an example method for performing the online calibration per the improved techniques described herein.

FIGS. 8A, 8B, 8C, and 8D are plots illustrating the behavior of various estimates of the hinge rotation over time.

### DETAILED DESCRIPTION

This disclosure relates to the wearing and use of smartglasses and maintaining a degree of user comfort during use of the smartglasses. A technical problem with smartglasses is that the maintenance of comfort for the user is difficult to achieve. Maintaining a degree of comfort, on the one hand, indicates that a frame of the smartglasses may be flexible to a certain degree. On the other hand, maintaining a degree of comfort indicates that the display be projected where the user is looking. Because the determination of where the user is looking is achieved via an eye-tracking camera disposed on the frame, an at least partially flexible frame may induce deformations that deflect the orientation of the eye-tracking camera enough to misalign the display from the user's gaze direction.

In accordance with the implementations described herein, a technical solution to the above-described technical problem includes performing a calibration of frame deformation to correct display position in the lens, in particular on online deformation. Such a calibration involves modeling the frame portion between the world-facing camera and the eye-tracking camera as a hinge that rotates about an axis on and normal to the frame portion. That is, the frame portion consists of two line segments that are joined at an axis at an unknown rotation (angle) to be determined. In this treatment, any translation induced will be neglected.

In some implementations, the hinge rotation is determined via at least one measurement from respective gyros attached to (associated with) the world-facing camera and the eye-tracking camera. The gyros measure the rotational velocities of the world-facing camera and the eye-tracking camera. At a given instant of time, a value for a hinge rotation parameter (hinge rotation value) in the form of a hinge rotation angle θ may be determined from the following equation:

$$θ = a tan 2 ( \frac{- {ω}_{2} \cdot ( \hat{r} \times {ω}_{1} )}{{‖ \hat{r} \times {ω}_{1} ‖}^{2}} , \frac{- {ω}_{2} \cdot ( \hat{r} \times ( \hat{r} \times {ω}_{1} ) )}{{‖ \hat{r} \times ( \hat{r} \times {ω}_{1} ) ‖}^{2}} ) ,$$

where ω₁ is the measured rotational velocity of the world-facing camera as measured by a first gyro, ω₂ is the measured rotational velocity of the eye-tracking camera as measured by a second gyro, and \hat{r} is the direction of the hinge axis. In some implementations, the direction of the hinge axis may be taken to be the vertical direction. In some implementations, the hinge rotation is a mean of several hinge rotations, each such rotation determined from a separate measurement pair and/or separate hinge rotation parameters such as separate hinge rotation angles.

The above hinge rotation determination (“hand-eye” method) may be performed in the absence of noise. This determination is not robust in the presence of noise, however. In some implementations, it may be assumed that there is a gaussian white noise present in the cameras and/or measurement process. In this case, we may evaluate an extended Kalman filter (EKF) to determine the hinge rotation in the presence of such noise.

Note that nominally ω₁=R₁₂ω₂, where R₁₂ is a rotation of the eye-tracking camera in the frame of the world-facing camera. Note that, while R₁₂ is a 3×3 matrix, there may only be three independent elements in that matrix. In any case, it is this rotation matrix that forms a state in a 3-degree of freedom (3DoF) system defined by an EKF.

In some implementations, the above hinge rotation determination may be performed in the absence of bias. Nevertheless, frame deformations may also be caused by certain long-timescale events such as a change in temperature or an aging of the frame materials. Moreover, frame deformations may also be caused by non-flexing motions such as sudden shocks caused by, e.g., dropping. These factors give rise to a rotational bias for each of the first gyro and the second gyro. It is these rotational biases, along with the rotation matrix, that defines a state of an EKF.

A technical advantage of the technical solution is that the EKF converges quickly enough so that the hinge rotation may be determined accurately in real time over relatively large time spans without accumulating significant error. Such an accurate determination of the hinge rotation translates into accurate placement of the display within a flexible frame and comfort for the user.

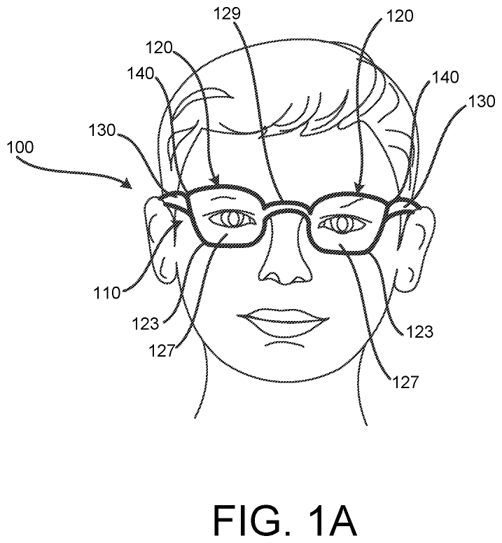

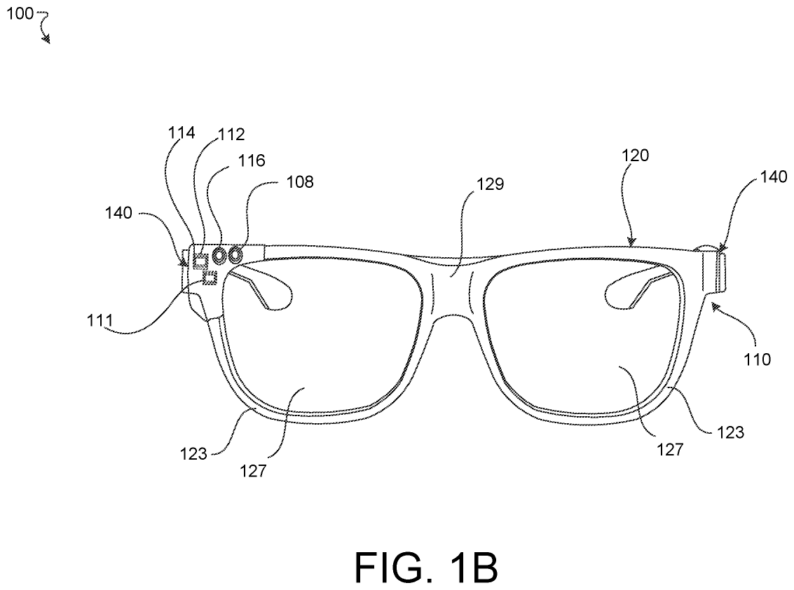

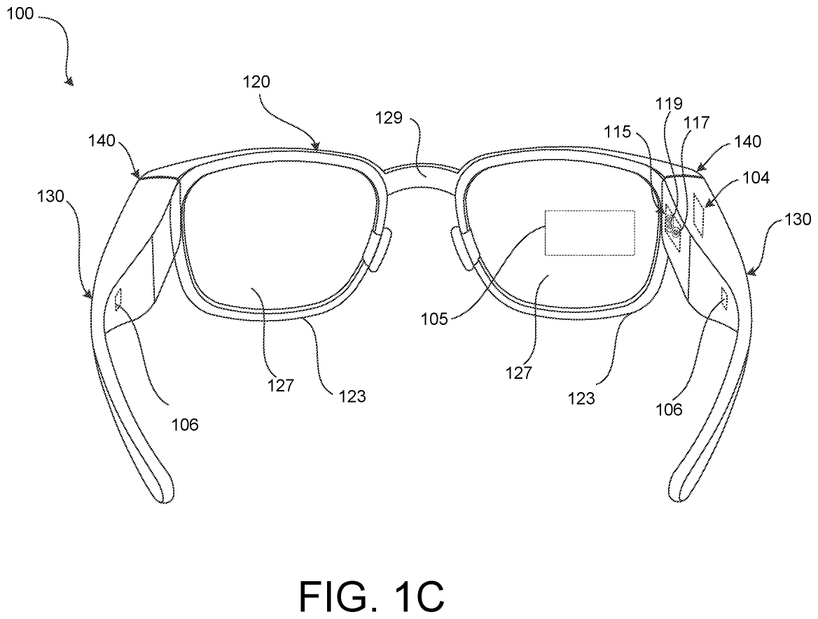

FIG. 1A illustrates a user wearing an example head mounted wearable device 100 in the form of smart glasses, or augmented reality glasses, including display capability, eye/gaze tracking capability, and computing/processing capability. FIG. 1B is a front view, and FIG. 1C is a rear view, of the example head mounted wearable device 100 shown in FIG. 1A. The example head mounted wearable device 100 includes a frame 110. The frame 110 includes a front frame portion 120, and a pair of temple arm portions 130 rotatably coupled to the front frame portion 120 by respective hinge portions 140. The front frame portion 120 includes rim portions 123 surrounding respective optical portions in the form of lenses 127, with a bridge portion 129 connecting the rim portions 123. The temple arm portions 130 are coupled, for example, pivotably or rotatably coupled, to the front frame portion 120 at peripheral portions of the respective rim portions 123. In some examples, the lenses 127 are corrective/prescription lenses. In some examples, the lenses 127 are an optical material including glass and/or plastic portions that do not necessarily incorporate corrective/prescription parameters.

In some examples, the wearable device 100 includes a display device 104 that can output visual content, for example, at an output coupler 105, so that the visual content is visible to the user. In the example shown in FIGS. 1B and 1C, the display device 104 is provided in one of the two arm portions 130, simply for purposes of discussion and illustration. Display devices 104 may be provided in each of the two arm portions 130 to provide for binocular output of content. In some examples, the display device 104 may be a see through near eye display. In some examples, the display device 104 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 127, next to content (for example, digital images, user interface elements, virtual content, and the like) output by the display device 104. In some implementations, waveguide optics may be used to depict content on the display device 104.

In some examples, the head mounted wearable device 100 includes one or more of an audio output device 106 (such as, for example, one or more speakers), an illumination device 108, a sensing system 111, a control system 112, at least one processor 114, and an outward facing image sensor 116, or camera 116. In some examples, the sensing system 111 may include various sensing devices and the control system 112 may include various control system devices including, for example, one or more processors 114 operably coupled to the components of the control system 112. In some examples, the control system 112 may include a communication module providing for communication and exchange of information between the wearable computing device 100 and other external devices. In some examples, the head mounted wearable device 100 includes a gaze tracking device 115 to detect and track eye gaze direction and movement. Data captured by the gaze tracking device 115 may be processed to detect and track gaze direction and movement as a user input. In the example shown in FIGS. 1B and 1C, the gaze tracking device 115 is provided in one of the two arm portions 130, simply for purposes of discussion and illustration. In the example arrangement shown in FIGS. 1B and 1C, the eye tracking device 115 is provided in the same arm portion 130 as the display device 104, so that user eye gaze can be tracked not only with respect to objects in the physical environment, but also with respect to the content output for display by the display device 104. In some examples, gaze, or eye-tracking devices 115 may be provided in each of the two arm portions 130 to provide for gaze tracking of each of the two eyes of the user. In some examples, display devices 104 may be provided in each of the two arm portions 130 to provide for binocular display of visual content.

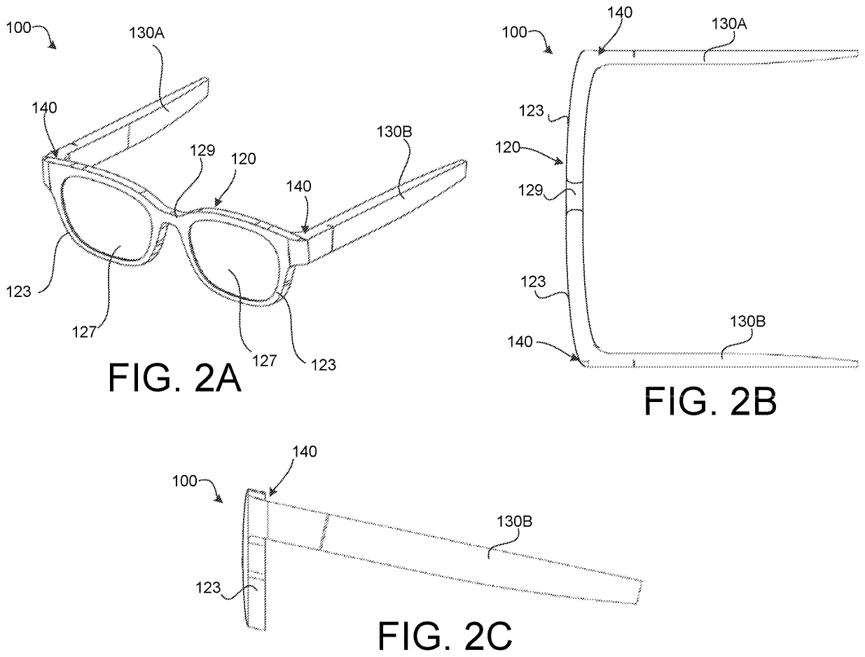

In some situations, the frame 110 of the head mounted wearable device 100 may experience deflection, or deformation. This may occur due to, for example, a head size and/or shape of the user wearing the head mounted wearable device 100, movement or slippage of the head mounted wearable device 100, and other such factors. Deformation or deflection or slippage that causes, for example, a relative shift in position and/or orientation between the image sensor 117 and the lens 127 may affect the accuracy of eye/gaze tracking performed based on the images captured by the image sensor 117 of the eye-tracking device 115. Similarly, deformation or deflection or slippage that causes a relative shift in position and/or orientation between one or both of the arm portion(s) 130 in which the display device(s) 104 is/are provided and the front frame portion 120 of the frame 110 may the user's ability to view visual content output by the display device 104. FIGS. 2A-2C provide a perspective view, a top view, and a side view of the frame 110 of the head mounted wearable device 100 in an at-rest state, or a baseline state, or a reference state. In the reference state, little to no forces are applied to the frame 110 that cause any type of deflection, or deformation of the frame 110. In some examples, the eye-tracking device 115 may be calibrated with the frame 110 in the reference state, so that eye tracking done by the eye-tracking device 115 may be coordinated with content output for display by the display device 104, for the detection of user inputs and/or interactions with the content and/or with objects in the physical environment, and the like.

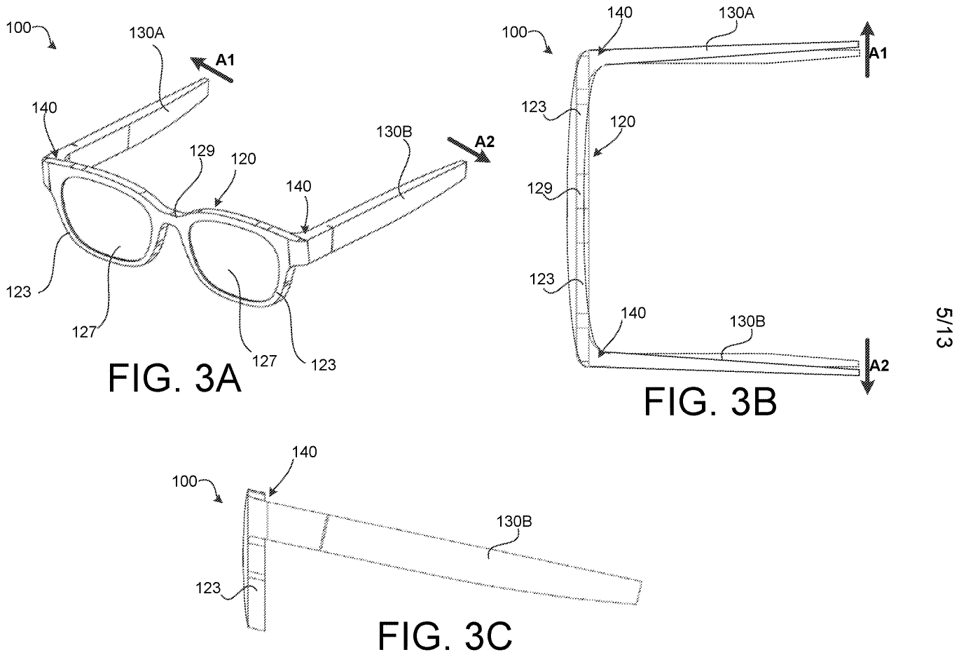

FIGS. 3A-3C provide a perspective view, a top view, and a side view, of the frame 110 of the head mounted wearable device 100, in a first example deformed state. In the state shown in FIGS. 3A-3C, a force has been applied to the frame 110 causing one or both of the temple arm portions 130 to be deflected outward. In particular, a first force has been applied to a first temple arm 130A, causing the first temple arm 130A to be deflected outward, in the direction of the arrow A1. A second force has been applied to a second temple arm 130B, causing the second temple arm 130B to be deflected in the direction of the arrow A2. In FIG. 3B, the position of the temple arm portions 130 in the reference state are shown in dashed lines, so that the deflection from the reference state is visible. This outward deflection of the temple arm portions 130 may be due to, for example, the head size of the user being relatively large compared to with width of the front frame portion 120 of the frame 110, shifting of the head mounted wearable device 100 on the head of the user, and the like. In this example, the outward deflection of the temple arm portions 130 has also caused a change in contour of the front frame portion 120 of the frame 110. In FIGS. 3B and 3C, the contour of the front frame portion 120 in the reference state is shown in dashed lines, so that the change in contour is visible.

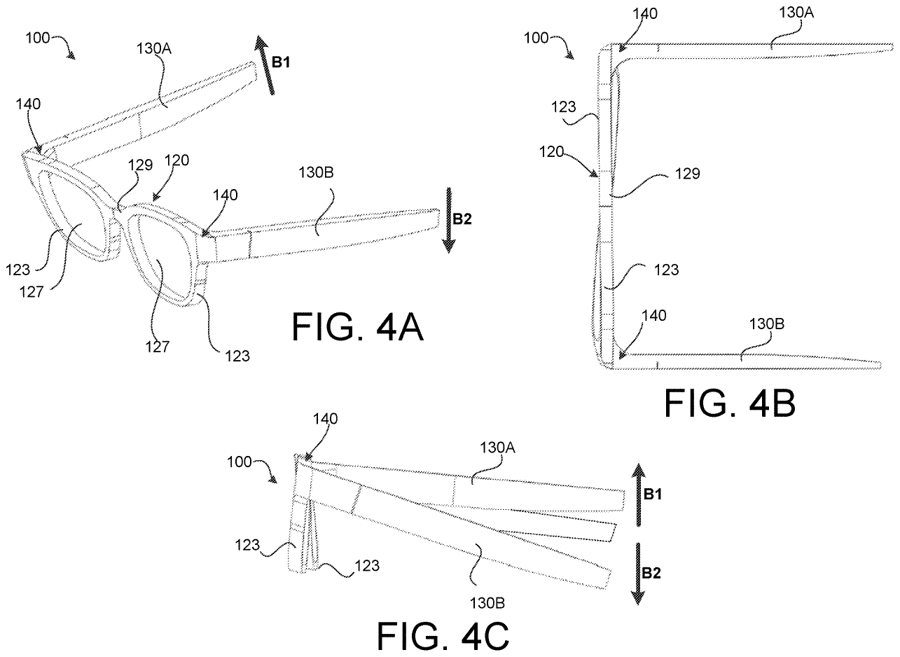

FIGS. 4A-4C provide a perspective view, a top view, and a side view, of the frame 110 of the head mounted wearable device 100, in a second example deformed state in which a twisting force has been applied to the frame 110. In the state shown in FIGS. 4A-4C, a first force has been applied to the first temple arm 130A, causing the first temple arm 130A to be deflected upward, in the direction of the arrow B1, and a second force has been applied to the second temple arm 130B, causing the second temple arm 130B to be deflected downward, in the direction of the arrow B2. In FIG. 4C, the position of the first temple arm 130A and the second temple arm 130B in the at rest state is shown in dashed lines, so that the deflection is visible. The deflection of the first temple arm 130A and the second temple arm 130B in this manner may be due to, for example, a shifting of the head mounted wearable device 100 on the head of the user, wear at the hinge portions 140, and the like. In this example, the deflection of the temple arm portions 130 has also caused twisting of the front frame portion 120 of the frame 110, as can be seen in FIG. 4C.

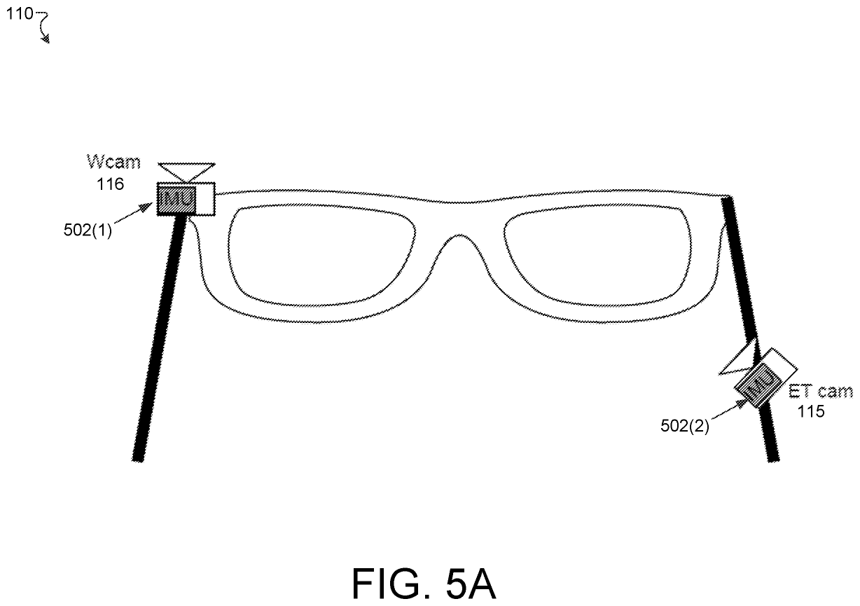

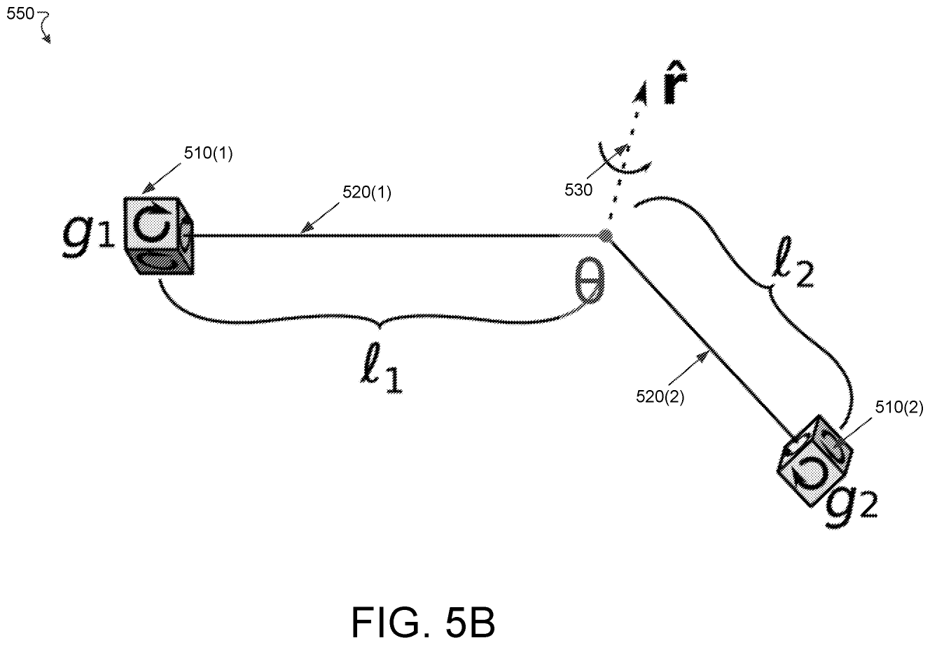

The first example deformed state and the second example deformed state shown in FIGS. 4A-5C provide just two examples of how deflection of the temple arm portions 130 of the frame 110 may cause deformation of the frame 110, which may result in a shifting of a relative position and/or orientation of the image sensor 117 and the lens 127 from which the image of the user's eye is captured. The principles to be described herein may be applied in response to other types of deformation experienced by the frame 110 that are not explicitly shown herein. The shift (from the reference state, at which the eye tracking device was calibrated) in position and/or orientation of the image sensor 117 relative to the lens 127, from which the image of the user's eye is captured, may affect the accuracy of eye/gaze tracking performed by the eye-tracking device 115. For example, depending on a degree or amount of deformation experienced by the frame 110, the corresponding shift in position/orientation of the eye tracking device 115 relative to the lens 127, from the reference state to the deformed state, may fall outside of the calibration thresholds (e.g., a hinge rotation value that varies from a nominal value by more than about four arcminutes), and adversely affect the accuracy of the eye/gaze tracking performed by the eye tracking device eye-tracking device 115. Similarly, depending on a degree or amount of deformation experienced by the frame 110, the corresponding shift in position/orientation of the display device 104 relative to the lens 127, from the reference state to the deformed state, may fall outside of the calibration thresholds of the display device, and adversely affect the user's visibility of visual content output by the display device 104. The trend toward lighter weight, smaller form factor head mounted wearable devices may make the frame 110 more susceptible to deflection and/or deformation and/or slippage. This, coupled with the increasing use of eye/gaze tracking as a user input mode/for user interaction with content and/or objects in the physical environment, puts more emphasis on the ability to detect/estimate deformation/slippage, and to provide for the recalibration of the eye-tracking device 115 to correct for the deformation and preserve accuracy of the eye/gaze tracking.

Systems and methods, in accordance with implementations described herein, provide for the detection of deformation and/or slippage of the frame of a head mounted wearable device, such as the example head mounted wearable device 100 described above. In particular, systems and methods, in accordance with implementations described above, provide for the detection of deformation and/or slippage of the frame, and the estimation of an amount or degree of deformation, so that it can be determined whether or not the detected deformation and/or slippage may cause a eye tracking device, such as the example eye tracking device 115 described above, to be outside of calibration thresholds that could adversely impact the accuracy of the output of the eye tracking device. Similarly, the estimation of an amount or degree of deformation may provide for a determination of whether or not the detected deformation and/or slippage may cause a display device, such as the example display device 104 described above, to be outside of calibration thresholds that could adversely impact the visibility of visual content output by the display device.

FIG. 5A is a diagram illustrating an example orientation between a world-facing camera 116 and an eye-tracking camera 115 on a smartglasses frame 110. If the smartglasses frame 110 were rigid, the world-facing camera 116 and the eye-tracking camera 115 would be in a fixed relative orientation. In such a scenario, the eye-tracking camera 115 would remain at a fixed orientation with respect to the eye of the user and would thereby be able to cause the display to be projected to the location in the lens at which the user is gazing.

Nevertheless, because the frame 110 is flexible, the world-facing camera 116 and the eye-tracking camera 115 are not in a fixed relative orientation due to frame deformations illustrated in FIGS. 2A-C, 3A-C, and 4A-C. Moreover, the frame deformation may also cause a change in position/orientation of the lenses and accordingly the display position may be changed even further.

As shown in FIG. 5A, each of the world-facing camera 116 and eye-tracking camera 115 has an attached inertial measurement unit (IMU) 502(1) and 502(2), respectively. Each IMU 502(1) and 502(2) includes a set of gyros configured to measure rotational motion, i.e., rotational velocity of each camera 115 and 116 are the camera moves on the frame due to deformation.

FIG. 5B is a diagram illustrating an example, simplified hinge model of the frame deformation of the frame portion 550 between the world-facing camera 116 and the eye-tracking camera 115. As shown in FIG. 5B, the simplified hinge model includes a first hinge arm 520(1) of length [symbol] ₁ and a second hinge arm 520(2) of length [symbol] ₂. The hinge arm 520(1) is terminated at a first gyro 510(1) corresponding to the world-facing camera 116 and the hinge arm 520(2) is terminated at a second gyro 510(2) corresponding to the eye-tracking camera 115. The first gyro 510(1) is configured to measure a first rotational velocity ω₁ and the second gyro 510(2) is configured to measure a second rotational velocity ω₂.

As shown in FIG. 5B, the simplified hinge model includes an axis 530 in the direction denoted as \hat{r}. At the hinge axis 530, the first hinge arm 520(1) makes an angle θ with respect to the second hinge arm 520(2). Nominally, as stated above,

$$θ = a tan 2 ( \frac{- {ω}_{2} \cdot ( \hat{r} \times {ω}_{1} )}{{‖ \hat{r} \times {ω}_{1} ‖}^{2}} , \frac{- {ω}_{2} \cdot ( \hat{r} \times ( \hat{r} \times {ω}_{1} ) )}{{‖ \hat{r} \times ( \hat{r} \times {ω}_{1} ) ‖}^{2}} ) .$$

Moreover, nominally ω₁=R₁₂ω₂, where R₁₂ is a rotation of the eye-tracking camera in the frame of the world-facing camera. Note that, while R₁₂ is a 3×3 matrix, there may only be three independent elements in that matrix. In some implementations, we may write R₁₂=exp([θ\hat{r}]ₓ), where [\hat{r}]ₓ is the skew-symmetric matrix corresponding to \hat{r}.

Accordingly, when there is noise and/or bias present in the measurement and/or process, we may instead use an EKF to determine the hinge rotation (rotation matrix). This is done by first considering the form of a noisy gyro measurement.

$${ω}_{1}^{′} = A {ω}_{1} + {ω}_{1}^{bias} + {ω}_{1}^{noise} ,$$

$${ω}_{2}^{′} = A {ω}_{2} + {ω}_{2}^{bias} + {ω}_{2}^{noise} ,$$

where

$${ω}_{1 , 2}^{′}$$

are the noisy gyro measurements of rotational velocity, A is a factory calibrated gyro gain matrix

$${ω}_{1 , 2}^{bias}$$

are respective gyro bias terms, and

$${ω}_{1 , 2}^{noise}$$

are respective noise terms. In some implementations, the

$${ω}_{1 , 2}^{noise}$$

are treated as gaussian white noise. In some implementations, the

$${ω}_{1 , 2}^{noise}$$

have identical widths and can be combined into a single noise term.

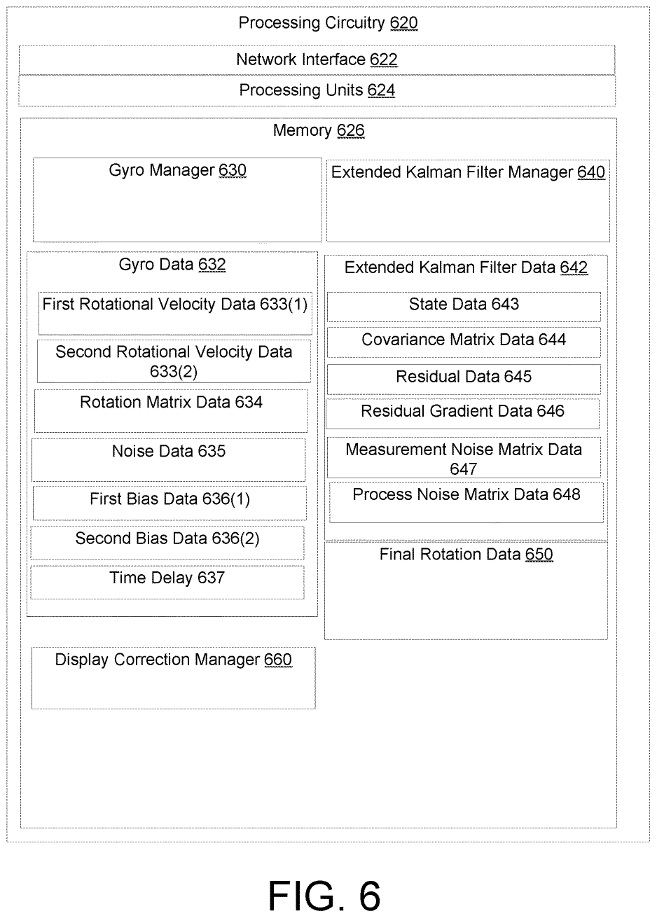

Details of the EKF process are described with regard to FIG. 6. The EKF process is carried out by processing circuitry embedded in the smartglasses, e.g., one or more processors 114 (FIG. 1B).

FIG. 6 is a diagram that illustrates an example of processing circuitry 620. The processing circuitry 620 includes a network interface 622, one or more processing units 624, and nontransitory memory 626. The network interface 622 includes, for example, Ethernet adaptors, Token Ring adaptors, and the like, for converting electronic and/or optical signals received from the network to electronic form for use by the processing circuitry 620. The set of processing units 624 include one or more processing chips and/or assemblies. The memory 626 includes both volatile memory (e.g., RAM) and non-volatile memory, such as one or more ROMs, disk drives, solid state drives, and the like. The set of processing units 624 and the memory 626 together form processing circuitry, which is configured and arranged to carry out various methods and functions as described herein.

In some implementations, one or more of the components of the processing circuitry 620 can be, or can include processors (e.g., processing units 624) configured to process instructions stored in the memory 626. Examples of such instructions as depicted in FIG. 6 include gyro manager 630, EKF manager 640, and display correction manager 660. Further, as illustrated in FIG. 6, the memory 626 is configured to store various data, which is described with respect to the respective managers that use such data.

The gyro manager 630 is configured to obtain gyro data 632. In some implementations, the gyro manager 630 obtains the gyro data 632 wirelessly, e.g., by a transmitter in an IMU containing the gyro.

The gyro data 632 represents the noisy gyro measurements of the rotational velocities at the world-facing camera and the eye-tracking camera. As shown in FIG. 6, the gyro data 632 includes first and second rotational velocity data 633(1,2), rotation matrix data 634, noise data 635, first and second bias data 636(1,2), and time delay data 637.

The first and second rotational velocity data 633(1,2), i.e.,

$${ω}_{1 , 2}^{′} ,$$

represent the measured rotational velocities of the world-facing camera and the eye-tracking camera as measured by their respective gyros. These measurements assume the presence of gaussian white noise and respective gyro biases. They may also be taken at different instants of time due to a delay in their reporting between the gyros.

The rotation matrix data 634 represents the unknown hinge rotation R₁₂ being sought. Knowledge of the rotation matrix allows the controller to correct the position of the display in the presence of frame deformations because the rotation matrix indicates a value of a hinge rotation that is used to characterize the frame deformation. Initially, the rotation matrix data 634 may be taken to be an undeformed rotation matrix between the two gyros.

The noise data 635 represents a gaussian white noise by which it is assumed the system possesses. Specifically, we may have the magnitude of the noise be a gaussian of zero mean and a width of about 0.077 deg/s. This term is treated as a function of time.

The first and second bias data 636(1,2) represent the unknown gyro bias terms

$${ω}_{1 , 2}^{bias} .$$

These bias terms come about due to several factors: temperature changes, frame material aging, and sudden shocks. Typically the bias terms are assumed constant within the timeframe of the measurements used here.

The time delay data 637 represents a time offset Δt that is used to compensate for clock misalignments between the IMUs that contain the gyros.

The EKF manager 640 is configured to perform an EKF process on the EKF data 642 and return final rotation data 650 that is used by the display correction manager 660 to place the display in the correct location in the smartglasses lens.

The EKF data 642 represents the state and covariances that are updated by the EKF manager 640, as well as the residual and error terms that are part of the updating equations. As shown in FIG. 6, the EKF data 642 includes state data 643, covariance matrix data 644, residual data 645, residual gradient data 646, measurement noise matrix data 647, and process noise matrix data 648.

State data 643 represents the state x that is updated by the EKF manager 640. Here, the state x is a 1×10 array where

$$x = [ Δ t , {R}_{12} , {ω}_{1}^{bias} , {ω}_{2}^{bias} ] .$$

R₁₂ as stated here is a 1×3 array of the three independent elements of a 3×3 rotation matrix.

Covariance matrix data 644 represents a 10×10 covariance matrix P, which is a measure of the accuracy of an estimate of the state x.

Residual data 645 represents a residual, or innovation vector, given here by

$$y ( t ) = {R}_{12} ( {ω}_{2}^{′} ( t + Δ t ) - {ω}_{2}^{bias} ) - ( {ω}_{1}^{′} ( t + Δ t ) - {ω}_{2}^{bias} ) .$$

Without noise and bias, the residual would be zero for all time. Because we assume the presence of noise and bias, the residual is nonzero but it is sought to make the residual as small as possible.

Residual gradient data 646 represents a 3×10 gradient H of the residual y(t) with respect to the state x.

Measurement noise matrix data 647 represents a 3×3 measurement noise matrix R. This represents the variances of the gyro measurement noises.

Process noise matrix data 648 represents a 10×10 process noise matrix Q. This represents the model errors, such as the slow changes of the gyro biases and the errors due to the linearization of the model.

The EKF manager 640 updates the state data 643 and covariance matrix data 644 through the following update equations.

$${HPH}^{T} + R \text{?} S$$

$${PH}^{T} {S}^{- 1} \text{?} K$$

$$x - Ky \text{?} x \text{(*} )$$

$$( I - KH ) P + Q \text{?} P \text{(*} \text{*)}$$

Note that (*) is the state updating equation, while (**) is the covariance matrix updating equation. The magnitude of the covariance matrix P should grow smaller with each iteration until a tolerance has been achieved. When the tolerance has been achieved, the state is the final state, and the rotation matrix of the state provides the final rotation data 650.

The components (e.g., modules, processing units 624) of processing circuitry 620 can be configured to operate based on one or more platforms (e.g., one or more similar or different platforms) that can include one or more types of hardware, software, firmware, operating systems, runtime libraries, and/or so forth. In some implementations, the components of the processing circuitry 620 can be configured to operate within a cluster of devices (e.g., a server farm). In such an implementation, the functionality and processing of the components of the processing circuitry 620 can be distributed to several devices of the cluster of devices.

The components of the processing circuitry 620 can be, or can include, any type of hardware and/or software configured to process attributes. In some implementations, one or more portions of the components shown in the components of the processing circuitry 620 in FIG. 6 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 620 can be, or can include, a software module configured for execution by at least one processor (not shown). In some implementations, the functionality of the components can be included in different modules and/or different components than those shown in FIG. 6, including combining functionality illustrated as two components into a single component.

Although not shown, in some implementations, the components of the processing circuitry 620 (or portions thereof) can be configured to operate within, for example, a data center (e.g., a cloud computing environment), a computer system, one or more server/host devices, and/or so forth. In some implementations, the components of the processing circuitry 620 (or portions thereof) can be configured to operate within a network. Thus, the components of the processing circuitry 620 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, gyro manager 630 (and/or a portion thereof), EKF manager 640 (and/or a portion thereof), and display correction manager 660 (and/or a portion thereof are examples of such instructions.

In some implementations, the memory 626 can be any type of memory such as a random-access memory, a disk drive memory, flash memory, and/or so forth. In some implementations, the memory 626 can be implemented as more than one memory component (e.g., more than one RAM component or disk drive memory) associated with the components of the processing circuitry 620. In some implementations, the memory 626 can be a database memory. In some implementations, the memory 626 can be, or can include, a non-local memory. For example, the memory 626 can be, or can include, a memory shared by multiple devices (not shown). In some implementations, the memory 626 can be associated with a server device (not shown) within a network and configured to serve the components of the processing circuitry 620.

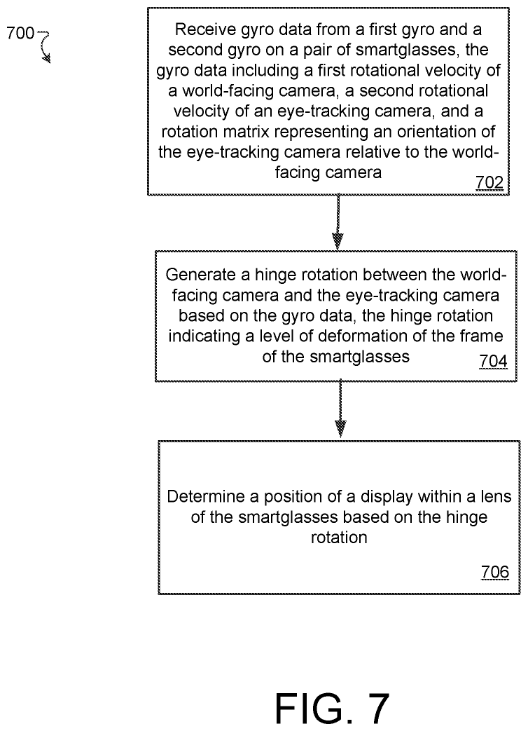

FIG. 7 is a flow chart depicting an example method 700 of producing corrected wavefronts for image calibration. The method 700 may be performed by software constructs described in connection with FIG. 6, which reside in memory 626 of the processing circuitry 620 and are run by the set of processing units 624.

At 702, the gyro manager 630 gyro data 632 from a first gyro 510(1) and a second gyro 510(2) on a smartglasses device 100, the first gyro being associated with a world-facing camera 116 on a frame 110 of the smartglasses device, the second gyro being associated with an eye-tracking camera 115 on a frame of the smartglasses device, the gyro data including a first rotational velocity (e.g., rotational velocity data 633(1)) of the world-facing camera, a second rotational velocity (e.g., rotational velocity data 633(2)) of the eye-tracking camera, and a rotation matrix (e.g., rotation matrix data 634) representing an orientation of the eye-tracking camera relative to the world-facing camera.

At 704, the EKF manager 640 generates a hinge rotation (e.g., represented by R₁₂ as part of state data 643) between the world-facing camera and the eye-tracking camera based on the gyro data, wherein the hinge rotation and its values representing the determined (current) hinge rotation indicate a level of deformation of the frame of the smartglasses which can be compared against calibration thresholds. In some implementations, a calibration threshold is whether the hinge rotation value varies from a nominal value (i.e., an equilibrium angle between the world-facing camera and the eye-tracking camera on the frame) by more than four arcminutes.

At 706, the display correction manager 660 determines a position of a display (e.g., visual content output by the display device 104) within a lens 127 of the smartglasses device based on the hinge rotation; in some implementations, the position of the display is changed from a nominal position as determined by the eye-tracking camera if the value of the hinge rotation varies by a nominal value by more than four arcminutes.

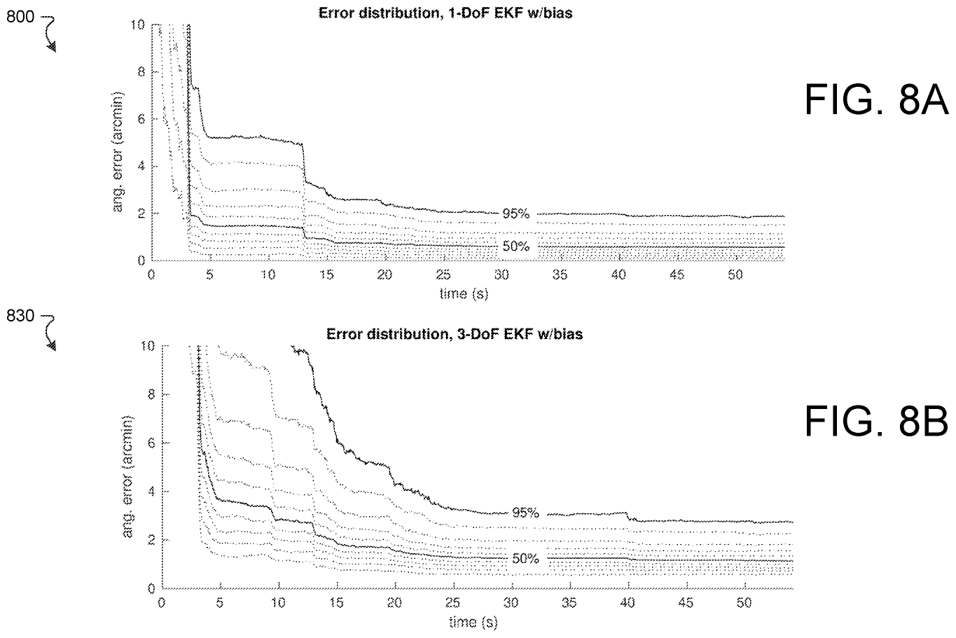

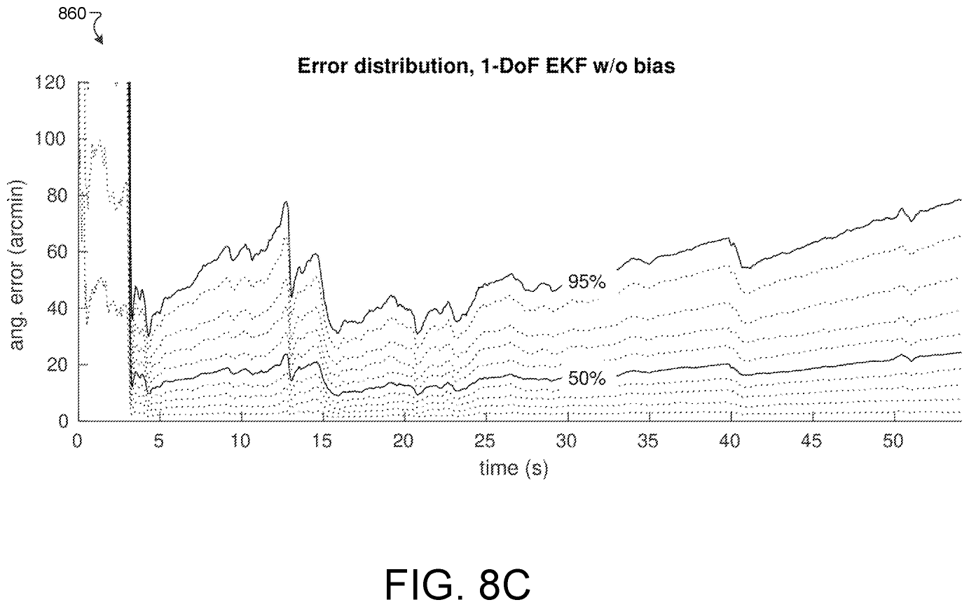

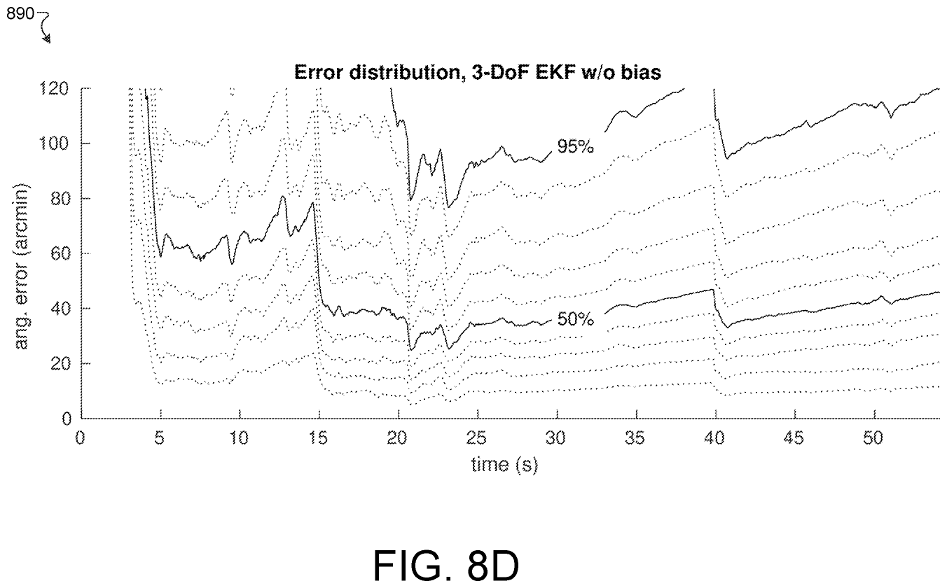

FIG. 8A is a plot 800 of simulations of frame deformations over time according to the (1-DoF EKF) hinge model illustrated in FIG. 5B, with bias. This plot represents 1000 runs of the algorithm on a 50-second, 30 Hz gyro dataset, collected from a head-mounted display ω₁(t). For each run, a 1-DoF relative rotation was randomly generated along with a simulated second gyro dataset ω₂(t). Simulated noise and bias were added to both gyro datasets, and the algorithm was run on both noisy datasets. The lines mark the 10^{th}, 20^{th}, . . . , 95^{th} percentile errors at each point in time, considered over the 1000 runs.

FIG. 8B is a plot 830 of simulations of frame deformations over time according to the (3-DoF EKF) hinge model illustrated in FIG. 5B, with bias. This plot represents 1000 runs of the algorithm on a 50-second, 30 Hz gyro dataset, collected from a head-mounted display ω₁(t). For each run, a 1-DoF relative rotation was randomly generated along with a simulated second gyro dataset ω₂(t). Simulated noise and bias were added to both gyro datasets, and the algorithm was run on both noisy datasets. The lines mark the 10^{th}, 20^{th}, . . . , 95^{th} percentile errors at each point in time, considered over the 1000 runs.

FIG. 8C is a plot 860 of simulations of frame deformations over time according to the (1-DoF EKF) hinge model illustrated in FIG. 5B, without bias. This plot represents 1000 runs of the algorithm on a 50-second, 30 Hz gyro dataset, collected from a head-mounted display ω₁(t). For each run, a 1-DoF relative rotation was randomly generated along with a simulated second gyro dataset ω₂(t). Simulated noise and bias were added to both gyro datasets, and the algorithm was run on both noisy datasets. The lines mark the 10^{th}, 20^{th}, . . . , 95^{th} percentile errors at each point in time, considered over the 1000 runs. The uncompensated estimates tend to drift away during periods of low motion, giving these plots a saw-toothed appearance.

FIG. 8D is a plot 890 of simulations of frame deformations over time according to the 3-DoF EKF) hinge model illustrated in FIG. 5B, without bias. This plot represents 1000 runs of the algorithm on a 50-second, 30 Hz gyro dataset, collected from a head-mounted display ω₁(t). For each run, a 1-DoF relative rotation was randomly generated along with a simulated second gyro dataset ω₂(t). Simulated noise and bias were added to both gyro datasets, and the algorithm was run on both noisy datasets. The lines mark the 10^{th}, 20^{th}, . . . , 95^{th} percentile errors at each point in time, considered over the 1000 runs. The uncompensated estimates tend to drift away during periods of low motion, giving these plots a saw-toothed appearance.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method, comprising:
receiving gyro data from a first gyro and a second gyro on a smartglasses device, the first gyro being associated with a world-facing camera on a frame of the smartglasses device, the second gyro being associated with an eye-tracking camera on a frame of the smartglasses device, the gyro data representing a first rotational velocity of the world-facing camera, a second rotational velocity of the eye-tracking camera, and a rotation matrix for an orientation of the eye-tracking camera relative to the world-facing camera;
generating at least one hinge rotation value relating to a hinge rotation between the world-facing camera and the eye-tracking camera based on the gyro data, the at least one hinge rotation value indicating a level of deformation of the frame of the smartglasses device; and
determining a position of a display within a lens of the smartglasses device based on the at least one hinge rotation value.

2. The method as in claim 1, wherein the gyro data includes a first noise term representing noise in the first gyro and a second noise term representing noise in the second gyro.

3. The method as in claim 2, wherein the first noise term and the second noise term are each gaussian white noise terms of equal width.

4. The method as in claim 1, wherein the gyro data includes a first bias term representing a rotational bias in the first gyro and a second bias term representing the rotational bias in the second gyro.

5. The method as in claim 4, wherein the first bias term and the second bias term are each constant with respect to time.

6. The method as in claim 1, wherein the gyro data includes a time delay between the world-facing camera and the eye-tracking camera.

7. The method as in claim 1, wherein generating the hinge rotation between the world-facing camera and the eye-tracking camera includes:
forming an initial state defined by the rotation matrix, an initial covariance matrix, a measurement noise matrix, and a process noise matrix; and
applying an extended Kalman filter to the initial state, the first rotational velocity, and the second rotational velocity to produce an updated state estimate and an updated covariance matrix, the at least one hinge rotation value being based on an updated rotation matrix of the updated state estimate.

8. The method as in claim 1, wherein generating the hinge rotation between the world-facing camera and the eye-tracking camera includes:
forming an initial state defined by:
the rotation matrix,
a first bias term representing a rotational bias in the first gyro,
a second bias term representing the rotational bias in the second gyro, and
a time delay between the world-facing camera and the eye-tracking camera;
forming an initial covariance matrix, a measurement noise matrix, and a process noise matrix; and
applying an extended Kalman filter to the initial state, the first rotational velocity, and the second rotational velocity to produce an updated state estimate and an updated covariance matrix, the at least one hinge rotation value being based on an updated rotation matrix of the updated state estimate.

9. A computer program product comprising a nontransitory storage medium, the computer program product including code that, when executed by processing circuitry, causes the processing circuitry to perform a method, the method comprising:
receiving gyro data from a first gyro and a second gyro on a smartglasses device, the first gyro being associated with a world-facing camera on a frame of the smartglasses device, the second gyro being associated with an eye-tracking camera on the frame of the smartglasses device, the gyro data representing a first rotational velocity of the world-facing camera, a second rotational velocity of the eye-tracking camera, and a rotation matrix for an orientation of the eye-tracking camera relative to the world-facing camera;
generating at least one hinge rotation value relating to a hinge rotation between the world-facing camera and the eye-tracking camera based on the gyro data, the at least one hinge rotation value indicating a level of deformation of the frame of the smartglasses device; and
determining a position of a display within a lens of the smartglasses device based on the at least one hinge rotation value.

10. The computer program product as in claim 9, wherein the gyro data includes a first noise term representing noise in the first gyro and a second noise term representing noise in the second gyro.

11. The computer program product as in claim 10, wherein the first noise term and the second noise term are each gaussian white noise terms of equal width.

12. The computer program product as in claim 9, wherein the gyro data includes a first bias term representing a rotational bias in the first gyro and a second bias term representing the rotational bias in the second gyro.

13. The computer program product as in claim 12, where in the first bias term and the second bias term are each constant with respect to time.

14. The computer program product as in any of the preceding claims, wherein the gyro data includes a time delay between the world-facing camera and the eye-tracking camera.

15. The computer program product as in claim 1, wherein generating the hinge rotation between the world-facing camera and the eye-tracking camera includes:
forming an initial state defined by the rotation matrix, an initial covariance matrix, a measurement noise matrix, and a process noise matrix; and
applying an extended Kalman filter to the initial state, the first rotational velocity, and the second rotational velocity to produce an updated state estimate and an updated covariance matrix, the at least one hinge rotation value being based on an updated rotation matrix of the updated state estimate.

16. The computer program product as in claim 1, wherein generating the hinge rotation between the world-facing camera and the eye-tracking camera includes:
forming an initial state defined by:
the rotation matrix,
a first bias term representing a rotational bias in the first gyro,
a second bias term representing the rotational bias in the second gyro, and
a time delay between the world-facing camera and the eye-tracking camera;
forming an initial covariance matrix, a measurement noise matrix, and a process noise matrix; and
applying an extended Kalman filter to the initial state, the first rotational velocity, and the second rotational velocity to produce an updated state estimate and an updated covariance matrix, the at least one hinge rotation value being based on an updated rotation matrix of the updated state estimate.

17. An apparatus, comprising:
memory; and
processing circuitry coupled to the memory, the processing circuitry being configured to:
receive gyro data from a first gyro and a second gyro on a smartglasses device, the first gyro being associated with a world-facing camera on a frame of the smartglasses device, the second gyro being associated with an eye-tracking camera on the frame of the smartglasses device, the gyro data representing a first rotational velocity of the world-facing camera, a second rotational velocity of the eye-tracking camera, and a rotation matrix for an orientation of the eye-tracking camera relative to the world-facing camera;
generate at least one hinge rotation value relating to a hinge rotation between the world-facing camera and the eye-tracking camera based on the gyro data, the at least one hinge rotation value indicating a level of deformation of the frame of the smartglasses device; and
determine a position of a display within a lens of the smartglasses device based on the at least one hinge rotation value.

18. The apparatus as in claim 17, wherein the processing circuitry configured to generate the hinge rotation between the world-facing camera and the eye-tracking camera is further configured to:
form an initial state defined by the rotation matrix, an initial covariance matrix, a measurement noise matrix, and a process noise matrix; and
apply an extended Kalman filter to the initial state, the first rotational velocity, and the second rotational velocity to produce an updated state estimate and an updated covariance matrix, the at least one hinge rotation value being based on an updated rotation matrix of the updated state estimate.

19. The apparatus as in claim 17, wherein the processing circuitry configured to generate the hinge rotation between the world-facing camera and the eye-tracking camera is further configured to:
form an initial state defined by:
the rotation matrix,
a first bias term representing a rotational bias in the first gyro,
a second bias term representing the rotational bias in the second gyro, and
a time delay between the world-facing camera and the eye-tracking camera;
form an initial covariance matrix, a measurement noise matrix, and a process noise matrix; and
apply an extended Kalman filter to the initial state, the first rotational velocity, and the second rotational velocity to produce an updated state estimate and an updated covariance matrix, the at least one hinge rotation value being based on an updated rotation matrix of the updated state estimate.

20. The apparatus as in claim 17, wherein the processing circuitry is further configured to:
project the display onto the lens at the position.
